(19) United States
(12) Patent Application Publication
(10) Pub. No.: US 2014/0240502 A1
(43) Pub. Date: Aug. 28, 2014

(54) Device for Assisting a Driver Driving a Vehicle or for Independently Driving a Vehicle

(71) Applicant: Continental Teves AG & Co. oHG, Frankfurt (DE)

(72) Inventors: Matthias Strauss, Pfungstadt (DE); Stefan Lueke, Bad Homburg (DE)

(21) Appl. No.: 14/351,721

(22) PCT Filed: Oct. 1, 2012
(86) PCT No.: PCT/DE2012/100306

§ 371 Date: Apr. 14, 2014

(30) Foreign Application Priority Data
Oct. 14, 2011 (DE) 10 2011 116 169.8

(51) Int. Cl. H04N 7/18

(52) U.S. Cl. CPC H04N 7/181
USPC 348/148

(57) ABSTRACT

A device for assisting a driver driving a vehicle or for autonomously driving a vehicle includes several distance sensors (2, 4, 5) and camera sensors (1, 3), an evaluation unit, and a control unit. The distance sensors detect objects that are directly in front of and behind the vehicle. The camera sensors cover an area surrounding the vehicle. From the data of the distance and camera sensors, the evaluation unit determines a three-dimensional representation of the areas covered by the sensors. Taking the three dimensional representation into account, the control unit generates a piece of advice for the driver or intervenes in vehicle steering.

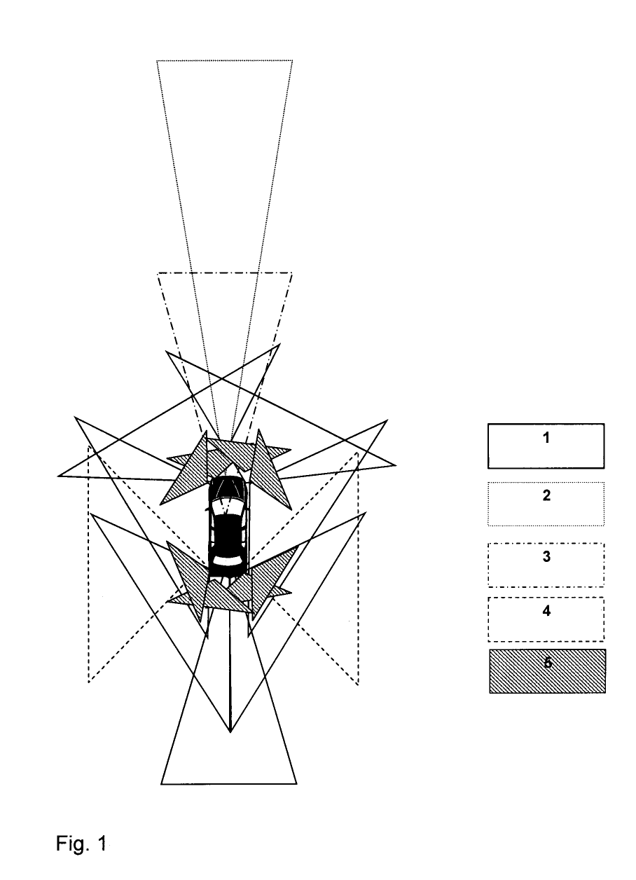

The invention relates to a device for assisting a driver driving a vehicle as well as a device for independently driving a vehicle.

Because of passive-safety requirements, modern vehicles are becoming more and more confusing, which may make driving maneuvers (e.g., getting into parking spaces in cramped multi-story car parks) difficult or even dangerous.

In order to counteract this trend, the number of sensors used to give the driver a better overview of the situation is steadily increasing. At first, such sensors were simple ultrasonic sensors informing the driver of the distance to possible obstacles by means of acoustic signals.

The introduction of navigation devices resulted in the widespread availability of monitors in vehicles. The monitors may be used, inter alia, to show the driver a top view of the vehicle and to indicate the distances between the objects and the vehicle.

These displays may also be used to show images acquired by a backup camera. In most cases, this camera is a fisheye camera capable of covering the entire area behind the vehicle.

Furthermore, additional information about the actual vehicle width and the trajectory may be superimposed on the camera image. Parking spaces detected by the ultrasonic sensors may also be displayed. Some systems even show the driver a trajectory that he or she is supposed to follow in order to get into a detected parking space.

Systems having several cameras for the entire surroundings of the vehicle are at least in the planning stage. By transforming the image data, photo-realistic surroundings of the entire vehicle can now be presented to the driver.

EP 2181892 A1 proposes a park assist system for a motor vehicle comprising four cameras for covering the four principal directions of the vehicle and several distance sensors.

The fact that objects are not always detected reliably since object information is only determined from data of the distance sensors whereas the camera data are used for presentation on a display may be considered as a disadvantage. When radar and ultrasonic sensors are used as distance sensors, an additional problem consists in the fact that the height of the objects cannot be measured at all or can only be measured very inaccurately.

The object of the present invention is to overcome the aforementioned disadvantages of the devices known from the state of the art.

This object is achieved by a device for assisting a driver driving a vehicle or for independently driving a vehicle. The device comprises several distance and camera sensors, an evaluation unit, and a control unit.

The distance sensors can detect objects that are directly in front of and behind the vehicle, e.g., within a range from centimeters to few meters in front of the bumpers of the vehicle. The distance sensors can also detect objects that are in front of or behind the vehicle and, at the same time, slightly at the side of the vehicle. The distance sensors should have a coverage that covers all directions in which the vehicle can directly drive.

The camera sensors cover an area surrounding the vehicle. Therefore, they are preferably designed as wide-angle cameras. The areas covered by adjacent wide-angle cameras may partially overlap.

From the data of the distance and camera sensors, the evaluation unit determines a three-dimensional representation of the covered areas, i.e., at least of the areas surrounding the front and the tail of the vehicle, but preferably of the 360° area surrounding the vehicle.

Taking the three-dimensional representation into account, the control unit generates a piece of advice for the driver or intervenes in vehicle steering.

Thus, the present sensor systems may be particularly used to take on part of the driver's tasks or even to drive completely independently.

An advantage of the invention consists in the fact that objects are detected reliably and safely. The three-dimensional representation of the immediate surroundings of the vehicle takes camera and distance sensor data into account and is therefore very robust.

Therefore, driving maneuvers can be planned or performed very precisely.

In a preferred embodiment, the evaluation unit creates a three-dimensional reconstruction from the data of at least one camera sensor by means of optical flow, i.e., 3D information of objects is reconstructed from the motion of these objects in a sequence of 2D camera images taking the proper motion of the camera into account.

The 3D information about the surroundings of the vehicle obtained from the reconstruction can be advantageously merged with the data of the distance sensors in a stationary grid.

According to an advantageous embodiment, the evaluation unit detects, while the vehicle is moving, from the data of at least one distance sensor whether an object in the covered area is moved relative to the stationary surroundings of the vehicle. Moved objects can be detected very well by means of, e.g., ultrasonic or radar sensors.

Advantageously, this information is also used to create a 3D reconstruction of the camera data. Moved objects distort such a reconstruction when the ego-vehicle is in motion. Camera data that correspond to a moved object are preferably disregarded when creating the three-dimensional reconstruction.

However, moved objects can be directly detected by the distance sensors, whereas stationary objects can be preferably detected from the camera data and, in addition to that, confirmed by data of at least one distance sensor.

Preferably, moved objects are detected from the data of at least one camera sensor when the vehicle is not in motion.

In a preferred embodiment, the cameras are arranged in or on the vehicle such that the viewing direction of the cameras that cover the area in front of or behind the vehicle is offset with respect to the longitudinal direction of the vehicle.

Advantageously, only or at least ultrasonic sensors are provided as distance sensors.

Alternatively or additionally, radar and/or lidar sensors are provided as distance sensors.

Preferably, at least one distance sensor is provided for the area at the right side of the vehicle and at least one distance sensor is provided for the area at the left side of the vehicle.

According to an advantageous realization of the invention, the maximum speed at which the control unit causes the vehicle to drive independently is dependent on the range of the camera and distance sensors in the direction of the trajectory that the control unit has determined for the vehicle.

In the following, the invention will be explained in greater detail on the basis of exemplary embodiments and one figure.

The figure schematically shows a configuration of different surroundings sensors of a vehicle covering different areas (1-5). It should be taken into account that the areas into which the vehicle can drive must be sufficiently monitored in order to be able to automate the driving task since a very large number of sensor configurations are conceivable and mainly depend on the apex angles and ranges of the sensors and on the shape of the vehicle.

In the configuration shown, several cameras are arranged in or on the vehicle, said cameras covering up to medium distances (e.g., up to about 100 meters) in the 360° surroundings of the vehicle by their individual covered areas (1, continuous boundary lines). Such a camera arrangement is used for panoramic-view display systems or top view systems. Top view systems typically show the vehicle and the surroundings of the vehicle from a bird's eye view.

When the vehicle is in motion, a 3D reconstruction of the imaged surroundings of the vehicle can be created from the image data of each individual camera by means of the optical-flow method. The proper motion of the camera can be determined if the entire optical flow in the image caused by static objects is known. This calculation can be advantageously simplified by using data such as the installation position in/on the vehicle and the motion of the vehicle to determine the proper motion, said data being particularly available from the vehicle sensors (e.g., speed sensor, steering-angle sensor or steering-wheel sensor, yaw rate sensor, pitch rate sensor, roll angle rate sensor). In the optical flow, characteristic point features can be tracked in successive images. Since the camera moves with the vehicle, three-dimensional information about these point features can be obtained by means of triangulation if the point features correspond to stationary objects in the surroundings of the vehicle.

This assignment can be performed easily and reliably when a distance sensor detects objects and their motion relative to the vehicle. Taking the proper motion of the vehicle into account, the distance sensor can finally determine whether an object is moving relative to the stationary surroundings of the vehicle or whether it is a stationary object. Moved objects can be detected very well by means of, e.g., ultrasonic or radar sensors. This information is used to create a 3D reconstruction of the camera data. Moved objects usually distort such a reconstruction when the ego-vehicle is in motion. Thus, moved objects can be directly detected by the distance sensors.

Static objects are first detected by the camera by means of the information from the 3D reconstruction and can then be confirmed as “objects that cannot be driven over” by measurements of at least one distance sensor.

The 3D reconstruction of data of a camera arranged in the direction of motion (i.e., in the longitudinal direction of the vehicle) is difficult because no information for 3D reconstruction is available in the center of expansion since there is only little or no change in image information in said center so that no information about objects is available. 3D information can only be obtained in the near range where the objects move downward and out of the image.

This means that the cameras must be mounted such that they do not directly look in the direction of motion but, at the same time, completely cover the surroundings of the vehicle together with the other sensors in order to ensure reliable detection. In the sensor configuration shown, the two cameras whose covered area (1) is directed forward are offset to the left/right at an angle of about 30 degrees with respect to the longitudinal direction/direction of motion of the vehicle. On the one hand, the area behind the vehicle is monitored by a rear-view camera arranged in the longitudinal direction. On the other hand, there are two further cameras looking diagonally backward. They together also cover the area behind the vehicle almost completely due to their large angles of coverage. In the figure, the viewing directions of these cameras looking diagonally backward are offset to the left/right at an angle of about 60 degrees with respect to the longitudinal direction/backward direction of the vehicle.

Alternatively to such an offset camera arrangement, other sensors arranged in the direction of motion may be provided. For example, lidar or stereo camera systems may be used to increase the reliability of and, above all, the range of object detection.

It is also possible to detect moved obstacles very well by means of a camera when the vehicle is not in motion, wherein detection may also be performed by means of an optical-flow method or a method for determining the change in image contents (difference image method). In these situations, the driver could be informed about pedestrians, cyclists or other vehicles with which the ego-vehicle could collide when the driver starts driving.

A long-range radar, typically having a frequency of 79 GHz, covers an area (2, dotted boundary line) extending far into the area in front of the vehicle (e.g., several hundred meters). Such radar sensors are often part of an ACC system (Adaptive Cruise Control).

A stereo camera monitors the area in front of the vehicle (3, dash-dot boundary line) up to medium distances and delivers spatial information about objects in this area.

Two short-range radar sensors, typically having a frequency of 24 GHz, monitor the covered areas (4, dashed boundary lines) at the sides of the vehicle. They are often used for blind spot detection, too.

Ultrasonic sensors monitor covered areas (5, hatched areas) that extend directly in front of the bumpers of the vehicle. Such ultrasonic sensors are often used to assist the driver in getting into a parking space. An advantage of this covered area (5) consists in the fact that all directions in which the vehicle can directly move are covered. However, the covered area does not extend very far in the longitudinal direction so that it is only sufficient for lower vehicle speed ranges. By taking into account the data and covered areas of the short-range radar sensors (4), of the stereo camera (3), of the lidar sensors (not shown in the figure) and/or of the long-range radar sensors (2), it is also possible to determine objects that are further away and to take them into account in autonomous vehicle steering, whereby a higher speed can be realized without cutting back on safety.

If reliable information about the surroundings of the vehicle delivered by the sensors is available, further-reaching functions can be realized in the vehicle (e.g., autonomous braking interventions and steering interventions) making an automatic search for parking spaces and automatic parking possible, wherein supportive steering interventions as well as supportive interventions in longitudinal control may be performed.

The high degree of reliable and spatial detection of the surroundings of the vehicle by means of such sensor configurations and evaluation methods makes the realization of further functions possible.

For example, the vehicle could search for parking spaces independently. To this end, the driver would have to align the vehicle parallel with the parked cars. After that, the system can automatically drive past the parked cars at low speed until it finds a parking space and stops. When conventional automatic transmissions are used, the driver would just have to shift into reverse and could have himself/herself driven into the parking space.

It would also be possible to switch to a sort of multi-story car park mode, in which the vehicle automatically searches for a parking space in a multi-story car park. The line markings on the ground can be detected by the parking cameras. Appropriate lane detection algorithms could be employed or adapted for these purposes. Right-of-way signs, signs indicating entry and exit rules as well as one-way street signs can be detected by a camera that is directed further forward (e.g., the stereo camera in the figure). The camera may also be a usual monocular driver assistance camera, on which a traffic sign recognition algorithm runs in this mode and, in addition to that, other algorithms such as automatic high beam control by means of detecting the lights of vehicles driving ahead or of oncoming vehicles.

Since object detection is very reliable in principle, the driver could, e.g., get out of the vehicle at the entrance to the multi-story car park and send the vehicle into the building where it searches for a parking space independently. It would also be possible to directly communicate the location of the nearest vacant parking space to the vehicle by means of car-to-x communication (C2X, communication between the vehicle and an infrastructure).

When the driver returns, the vehicle could also be activated by means of a special remote keyless entry fob in order to cause the vehicle to drive out of the multi-story car park, said remote keyless entry fob also including cell phone standards such as LTE or WLAN. The driver could be charged for using the multi-story car park via, e.g., the provider's cell phone bill.

It would also be possible to have local map data about the multi-story car park transmitted by a C2X unit in the multi-story car park so that the system can drive through the building more easily. These maps could include all positions of objects, including those of parked vehicles, so that a classification of the objects would not be necessary any more.

It is also conceivable that the vehicle independently (without a driver) searches for a parking space in a city center if the sensors are sufficiently accurate in every detail and sufficiently reliable, wherein the vehicle would preferably drive along parked vehicles and search for a vacant parking space. If it finds no vacant parking space in one street, the system can search for a parking space in other streets with the aid of navigation data. Additional preconditions for that would be a reliable recognition of traffic lights and right-of-way signs and the recognition of no-parking signs. In this mode, the vehicle would not actively take part in traffic but just slowly move along the street and could be passed by other vehicles.

1. A device for assisting a driver driving a vehicle or for autonomously driving a vehicle, comprising distance sensors and camera sensors, an evaluation unit and a control unit, wherein the distance sensors are arranged and configured to detect objects in first areas directly in front of and behind the vehicle, the camera sensors are a arranged and configured to monitor second areas surrounding the vehicle, the evaluation unit is configured to determine a three-dimensional representation of the first and second areas from data of the distance sensors and the camera sensors, and the control unit is configured to generate a piece of advice for the driver or to intervene in vehicle steering taking the three-dimensional representation into account.

2. The device according to claim 1, wherein the evaluation unit is configured to create a three-dimensional reconstruction from the data of at least one of the camera sensors by optical flow.

3. The device according to claim 2, wherein the evaluation unit is configured to detect, while the vehicle is moving, from the data of at least one of the distance sensors, whether an object in the respective first area is a moved object that moved relative to stationary surroundings of the vehicle.

4. The device according to claim 3, wherein data items of the data of the at least one of the camera sensors that correspond to the moved object are disregarded by the evaluation unit when creating the three-dimensional reconstruction.

5. The device according to claim 1, wherein moved objects are detected from the data of at least one of the camera sensors when the vehicle is not in motion.

6. The device according to claim 1 wherein the camera sensors are arranged such that respective viewing directions of the camera sensors that monitor the second areas in front of or behind the vehicle are offset with respect to a longitudinal direction of the vehicle.

7. The device according to claim 1 wherein the distance sensors comprise ultrasonic sensors.

8. The device according to claim 1, wherein the distance sensors comprise radar and/or lidar.

9. The device according to claim 1, wherein respectively at least one said distance sensor is additionally arranged to monitor the respective area at each side of the vehicle.

10. The device according to claim 1, wherein a maximum speed at which the control unit causes the vehicle to drive autonomously is dependent on a respective range of the camera sensors and the distance sensors in a direction of a trajectory that the control unit has determined for the vehicle.
